(19) United States
(12) Patent Application Publication
(10) Pub. No.: US 2026/0131598 A1
(43) Pub. Date: May 14, 2026

(54) TIRE PROVIDED WITH AN OUTER SIDEWALL BASED ON A COMPOSITION CONTAINING PYROLYSIS CARBON BLACK

(71) Applicant: COMPAGNIE GENERALE DES ETABLISSEMENTS MICHELIN, Clermont-Ferrand (FR)

(72) Inventors: MATHILDE FOURNIER, Clermont-Ferrand (FR); ANNE CHABROL, Clermont-Ferrand (FR)

(21) Appl. No.: 19/118,119

(22) PCT Filed: Oct. 4, 2023
(86) PCT No.: PCT/FR2023/051534

§ 371 Date: Apr. 3, 2025

(30) Foreign Application Priority Data
Oct. 4, 2022 (FR) 2210159

(51) Int. Cl. B60C 1/00; B60C 13/00; C08K 3/04; C08K 3/06; C08L 7/00; C08L 9/00

(52) U.S. Cl. CPC B60C 1/0025; C08K 3/04; C08K 3/06; C08L 7/00; C08L 9/00; B60C 2013/006; C08K 2201/006; C08L 2312/00

(57) ABSTRACT

Pneumatic tires and more particularly tire outer sidewalls have elastomeric layers located radially on the outside of the tire, which are in contact with the ambient air, and which are based on a composition containing pyrolysis carbon black

### FIELD OF THE INVENTION

The present invention relates to pneumatic tyres and more particularly to tyre outer sidewalls, that is to say, by definition, to the elastomeric layers located radially on the outside of the tyre, which are in contact with the ambient air.

### TECHNOLOGICAL BACKGROUND

Within a tyre, three regions are conventionally distinguished:
the radially exterior region in contact with the ambient air;
the radially interior region in contact with the inflation gas;
the internal region of the tyre.

The radially exterior region in contact with the ambient air essentially consists of the tread and of the outer sidewall of the tyre. An outer sidewall is an elastomeric layer positioned outside the carcass reinforcement relative to the internal cavity of the tyre, between the crown and the bead, so as to totally or partially cover the region of the carcass reinforcement extending from the crown to the bead.

The radially interior region in contact with the inflation gas generally consists of the layer airtight to the inflation gases, sometimes referred to as inner liner.

The internal region of the tyre is the region between the exterior and interior regions. This region includes layers or plies which are referred to here as internal layers of the tyre. These are, for example, carcass plies, tread sublayers, tyre belt plies or any other layer which is not in contact with the ambient air or the inflation gas of the tyre.

It is important for the performance qualities of the tyre for the region of the outer sidewall to have good performance qualities in terms of rolling resistance. Good performance qualities in terms of rolling resistance can be obtained by lowering the filler content of the rubber compositions and by using predominantly silica. However, it has been observed that lowering the content of filler in the rubber compositions leads to problems with the processability of the compositions, in particular to uncontrollable swelling of the compositions making them unsuitable for use in industrial equipment commonly used for the manufacture of tyres.

Thus, there remains a need to have available compositions which have both good processability and which in the cured state have good performance qualities, in particular in terms of rolling resistance, and which advantageously meet an increasingly present need to limit the environmental impact of the manufacture and the use of tyres.

### BRIEF DESCRIPTION OF THE INVENTION

The present invention relates to a tyre provided with an outer sidewall, the outer sidewall comprising at least one rubber composition based on:
at least one elastomer;
16% to 20% by volume, relative to the total volume of the composition, of reinforcing fillers; and
a crosslinking system;
   the reinforcing fillers comprising:
from 6% to 16%, preferably from 6% to 11%, by volume, relative to the total volume of the composition, of reinforcing fillers selected from the group consisting of reinforcing inorganic fillers, carbon blacks having a CTAB specific surface area of greater than or equal to 90 m²/g and mixtures of reinforcing inorganic fillers and of carbon blacks having a CTAB specific surface area of greater than or equal to 90 m²/g in which the reinforcing inorganic filler is predominant by mass;
pyrolysis carbon blacks in an amount sufficient to achieve a volume of reinforcing fillers in the composition ranging from 16% to 20% relative to the total volume of the composition.

Other aspects of the invention are as described below and in the claims.

### Definitions

The expression “composition based on” should be understood as meaning a composition comprising the mixture and/or the product of the in situ reaction of the various constituents used, some of these constituents being able to react and/or being intended to react with one another, at least partially, during the various phases of manufacture of the composition; it thus being possible for the composition to be in the completely or partially crosslinked state or in the noncrosslinked state.

The expression “part by weight per hundred parts by weight of elastomer” (or phr) should be understood as meaning, for the purposes of the present invention, the part by mass per hundred parts by mass of elastomer or of rubber, the two terms being synonymous.

In the present document, unless expressly indicated otherwise, all the percentages (%) indicated are percentages (%) by mass.

For the purposes of the present invention, the term “predominantly” means that the compound is predominant among the compounds of the same type in the composition, that is to say that it is the one which represents the greatest amount by mass among the compounds of the same type. In other words, the mass of this compound represents at least 51% of the total mass of the compounds of the same type in the composition. By way of example, in a system comprising just one elastomer, the latter is predominant within the meaning of the present invention; and in a system comprising two elastomers, the predominant elastomer represents more than half of the total mass of the elastomers, in other words the mass of this elastomer represents at least 51% of the total mass of the elastomers. In the same way, a “predominant” filler is the one representing the greatest mass among the fillers of the composition. In other words, the mass of this filler represents at least 51% of the total mass of the fillers in the composition.

Furthermore, any interval of values denoted by the expression “between a and b” represents the range of values extending from more than a to less than b (i.e. limits a and b excluded), whereas any interval of values denoted by the expression “from a to b” means the range of values extending from a up to b (i.e. including the strict limits a and b). In the present document, when an interval of values is described by the expression “from a to b”, the interval represented by the expression “between a and b” is also and preferentially described.

The expression “radial” refers to a radius of the tyre. It is within this meaning that a point P1 is said to be “radially interior” to a point P2 (or “radially inside” the point P2) if it is closer to the axis of rotation of the tyre than the point P2. Conversely, a point P3 is said to be “radially exterior to” a point P4 (or “radially outside” the point P4) if it is further away from the axis of rotation of the tyre than the point P4. It will be said that a movement is “radially inwards (or outwards)” when the movement is in the direction of the shorter (or longer) radii. This sense of the term also applies when it is a matter of radial distances. The term “radial cross section” or “radial section” is understood here to mean a cross section or a section along a plane that contains the axis of rotation of the tyre.

An “axial” direction is a direction parallel to the axis of rotation of the tyre. A point P5 is said to be “axially interior” to a point P6 (or “axially inside” the point P6) if it is closer to the median plane of the tyre than the point P6. Conversely, a point P7 is said to be “axially exterior to” a point P8 (or “axially outside” the point P8) if it is further from the median plane of the tyre than the point P8. The “median plane” of the tyre is the plane that is perpendicular to the axis of rotation of the tyre and that is located equidistantly from the annular reinforcing structures of each bead.

A “circumferential” direction is a direction that is perpendicular both to a radius of the tyre and to the axial direction.

The compounds comprising carbon mentioned in the description may be of fossil origin or biobased. In the latter case, they may be, partially or completely, derived from biomass or obtained from renewable raw materials derived from biomass. This particularly concerns polymers, plasticizers, fillers, etc.

### DETAILED DESCRIPTION OF THE INVENTION

The inventors have developed rubber compositions that meet the needs expressed. It has been demonstrated that the addition of pyrolysis carbon black to a rubber composition makes it possible to increase the content of fillers in the composition, and thus to promote its processability, without penalizing the performance qualities of the composition.

Thus, the present invention relates to a tyre provided with an outer sidewall, the outer sidewall comprising at least one rubber composition based on:
at least one elastomer;
16% to 20% by volume, relative to the total volume of the composition, of reinforcing fillers; and
a crosslinking system;
the reinforcing fillers comprising:
   from 6% to 16%, preferably from 6% to 11%, by volume, relative to the total volume of the composition, of reinforcing fillers selected from the group consisting of reinforcing inorganic fillers (preferably silica), carbon blacks having a CTAB specific surface area of greater than or equal to 90 m²/g and mixtures of reinforcing inorganic fillers (preferably silica) and of carbon blacks having a CTAB specific surface area of greater than or equal to 90 m²/g in which the reinforcing inorganic filler (preferably silica) is predominant by mass;
   pyrolysis carbon blacks in an amount sufficient to achieve a volume of reinforcing fillers in the composition ranging from 16% to 20% relative to the total volume of the composition.

The rubber composition may also comprise usual additives and processing aids.

The various constituents of the rubber composition may be as described below.

### Elastomer

The composition of use in the context of the present invention is based on at least one elastomer (or, without distinction, rubber).

The elastomer may be selected from the group consisting of diene elastomers and mixtures thereof.

The term “diene elastomer”, whether natural or synthetic, should be understood, in a known manner, as meaning an elastomer consisting, at least partly (i.e. a homopolymer or a copolymer) of diene monomer units (monomers bearing two conjugated or non-conjugated carbon-carbon double bonds).

These diene elastomers can be classified into two categories: “essentially unsaturated” or “essentially saturated”. The term “essentially unsaturated” is generally understood to mean a diene elastomer derived at least in part from conjugated diene monomers having a content of sub-units or units of diene origin (conjugated dienes) which is greater than 15% (mol %); thus, diene elastomers such as butyl rubbers or copolymers of dienes and of alpha-olefins of EPDM type do not fall under the preceding definition and may particularly be termed “essentially saturated” diene elastomers (low or very low content, always less than 15%, of sub-units of diene origin).

The term “diene elastomer capable of being used” particularly means:
(a)—any homopolymer obtained by polymerization of a conjugated or non-conjugated diene monomer having from 4 to 18 carbon atoms;
(b)—any copolymer obtained by copolymerization of a conjugated or non-conjugated diene having from 4 to 18 carbon atoms and of at least one other monomer.

The other monomer may be ethylene, an olefin or a conjugated or non-conjugated diene. Conjugated dienes that are suitable include conjugated dienes having from 4 to 12 carbon atoms, in particular 1,3-dienes, especially such as 1,3-butadiene and isoprene. Olefins that are suitable include vinylaromatic compounds having from 8 to 20 carbon atoms and aliphatic a-monoolefins having from 3 to 12 carbon atoms.

Vinylaromatic compounds that are suitable include, for example, styrene, ortho-, meta- or para-methylstyrene, the “vinyltoluene” commercial mixture or para-(tert-butyl) styrene. Suitable as aliphatic a-monoolefins are in particular acyclic aliphatic a-monoolefins having from 3 to 18 carbon atoms.

More particularly, the diene elastomer capable of being used in the compositions may be:
(a′)—any homopolymer obtained by polymerization of a conjugated diene monomer having from 4 to 12 carbon atoms;
(b′)—any copolymer obtained by copolymerization of one or more conjugated dienes with one another or with one or more vinylaromatic compounds having from 8 to 20 carbon atoms;
(c′)—any copolymer obtained by copolymerization of one or more conjugated or non-conjugated dienes with ethylene, an a-monoolefin or a mixture thereof, for instance the elastomers obtained from ethylene, from propylene with a non-conjugated diene monomer of the abovementioned type.

Preferentially, the diene elastomer is selected from the group consisting of polybutadienes (BRs), natural rubber (NR), synthetic polyisoprenes (IRs), butadiene copolymers, isoprene copolymers, and the mixtures of these elastomers. The butadiene copolymers are particularly selected from the group consisting of butadiene-styrene copolymers (SBRs).

The diene elastomer may be modified, i.e. either coupled and/or star-branched, or functionalized, or coupled and/or star-branched and simultaneously functionalized. Thus, the diene elastomer may be coupled and/or star-branched, for example by means of a silicon or tin atom which connects the elastomer chains together.

The diene elastomer may be simultaneously or alternatively functionalized and comprise at least one functional group. The term “functional group” is understood to mean a group comprising at least one heteroatom selected from Si, N, S, O or P. Particularly suitable as functional groups are those comprising at least one function, such as: silanol, an alkoxysilane, a primary, secondary or tertiary amine which is cyclic or non-cyclic, a thiol or an epoxide.

The rubber composition of use in the context of the invention may contain just one diene elastomer or a mixture of several diene elastomers.

In certain embodiments, the rubber composition of use in the context of the invention comprises one or more elastomers; it may thus comprise from 25 to 100 phr of natural rubber and from 0 to 75 phr of at least one polybutadiene, preferably from 35 to 75 phr of natural rubber and from 25 to 65 phr of at least one polybutadiene.

In certain embodiments, the rubber composition of use in the context of the invention comprises, as elastomer, a mixture of natural rubber (NR) and at least one polybutadiene (BR). Preferably, the mixture consists of 50 phr of natural rubber (NR) and 50 phr of polybutadiene (BR).

### Reinforcing Filler

The composition of use in the context of the present invention comprises reinforcing fillers. The reinforcing fillers represent from 16% to 20% by volume of the total volume of the composition.

The term “reinforcing filler” commonly denotes any type of filler known for its abilities to reinforce a rubber composition that can be used in particular for the manufacture of tyres, for example organic fillers such as carbon black or pyrolysis carbon black, or inorganic fillers such as silica or alumina.

The composition of use in the context of the present invention comprises:
from 6% to 16%, preferably from 6% to 11%, by volume, relative to the total volume of the composition, of reinforcing fillers selected from the group consisting of reinforcing inorganic fillers (preferably silica), carbon blacks having a CTAB specific surface area of greater than or equal to 90 m²/g and mixtures of reinforcing inorganic fillers (preferably silica) and of carbon blacks having a CTAB specific surface area of greater than or equal to 90 m²/g in which the reinforcing inorganic filler (preferably silica) is predominant by mass;
pyrolysis carbon blacks in an amount sufficient to achieve a volume of reinforcing fillers in the composition ranging from 16% to 20% relative to the total volume of the composition.

In certain embodiments, the composition of use in the context of the present invention comprises:
from 6% to 16%, preferably from 6% to 11%, by volume, relative to the total volume of the composition, of reinforcing fillers selected from the group consisting of reinforcing inorganic fillers (preferably silica) and mixtures of reinforcing inorganic fillers (preferably silica) and of carbon blacks having a CTAB specific surface area of greater than or equal to 90 m²/g in which the reinforcing inorganic filler (preferably silica) is predominant by mass;
pyrolysis carbon blacks in an amount sufficient to achieve a volume of reinforcing fillers in the composition ranging from 16% to 20% relative to the total volume of the composition.

Typically, the mixtures of inorganic fillers (preferably silica) and of carbon blacks having a CTAB specific surface area of greater than or equal to 90 m²/g in which the inorganic filler is predominant by mass comprise 10 volumes of inorganic fillers per 2 to 3 volumes of carbon blacks.

The CTAB specific surface area of the carbon blacks is determined according to the standard ASTM D3765-03a published in December 2003.

The reinforcing fillers may be as described below.

### Pyrolysis Carbon Black

For the purposes of the present invention, the term “pyrolysis carbon black” is understood to mean a carbon black resulting from a process for the pyrolysis of a material comprising at least a carbon-based polymer and a carbon black, hereinafter referred to as the material to be pyrolysed, for example in the context of the recycling of such a material. The physical state in which the material to be pyrolysed is provided is not important, whether it be in the form of a powder, granules, a strip, or any other form, in the crosslinked or noncrosslinked state.

Preferentially, the material to be pyrolysed may be recovered from manufactured articles or from products generated during their manufacture/production (such as by-products or scraps); these manufactured articles being able to be selected from the group consisting of pneumatic tyres, non-pneumatic tyres, industrial conveyor belts, transmission belts, rubber seals, rubber hoses, shoe soles and windscreen wipers. More preferentially still, the pyrolysis carbon black that can be used in the context of the present invention is a carbon black obtained from a pyrolysis process the material to be pyrolysed of which is derived from manufactured articles selected from the group consisting of pneumatic tyres and non-pneumatic tyres.

In the context of the present invention, “pyrolysis” means any type of thermal decomposition in the absence of oxygen and the raw material of which is the material to be pyrolysed as defined above. Pyrolysis carbon blacks thus differ from “industrial” and/or “ASTM-grade” carbon blacks in that the carbon-based raw material used for the pyrolysis is a material comprising at least a carbon-based polymer and a carbon black and not materials derived from petroleum cuts or derived from coal or else from oils of natural origin.

The pyrolysis carbon blacks that can be used in the context of the present invention differ from known carbon blacks such as industrial carbon blacks, in particular “furnace” carbon blacks, notably by a higher ash content.

Preferentially, the pyrolysis carbon black that can be used in the context of the present invention has an ash content within a range extending from 5% to 30% by weight, more preferentially ranging from 8% to 25% by weight, more preferentially still from 10% to 22% by weight, relative to the total weight of the pyrolysis carbon black.

Preferentially, the pyrolysis carbon black that can be used in the context of the present invention has a sulfur content of greater than 2% by weight, preferably 2.5% to 5% by weight, relative to the total weight of the pyrolysis carbon black.

Preferentially, the pyrolysis carbon black that can be used in the context of the present invention has a zinc content of greater than or equal to 2% by weight, preferably 2.5% to 8% by weight, relative to the total weight of the pyrolysis carbon black.

Preferentially, the pyrolysis carbon black that can be used in the context of the present invention has an STSA specific surface area measured in accordance with the standard ASTM D 6556-2021 within a range extending from 20 to 200 m²/g, more preferentially extending from 30 to 90 m²/g.

Preferentially, the pyrolysis carbon black that can be used in the context of the present invention has a void volume measured in accordance with the standard ASTM D7854-21 and at a pressure of 50 MPa within a range extending from 30 to 60 ml/100 g, more preferentially extending from 35 to 55 ml/100 g.

The ash content is determined by calcination in platinum dishes in a muffle furnace at 825° C. according to the following protocol. A dish is identified in advance before each series of measurements and is tared to within 0.1 mg and the mass is denoted P0. 5 g of pyrolysis carbon black sample are introduced into the dish, and this is weighed precisely to within 0.1 mg; this mass is denoted P1. The dish and its contents are pre-calcined using a Bunsen burner until smoke appears and the product ignites. Once the product has burnt completely, the dish and its contents are introduced into a muffle furnace heated at 825° C. for 1 hour. After 1 hour, the dish is removed from the furnace and immediately introduced into a desiccator at ambient temperature. When the dish and the ashes have returned to ambient temperature, the dish is weighed again to obtain the mass P2. Finally, it is possible to obtain the ash content (% ash) using the formula below:

$$\% ash = \frac{P 2 - P 0}{P 1 - P 0} \times 100$$

The content of zinc in the pyrolysis carbon black is realized after calcination of the sample, followed by take-up of the ashes in an acidic medium and assay by ICP-AES (inductively coupled plasma atomic emission spectroscopy). The ashes are obtained by carrying out the protocol above. About exactly 100 mg of ashes is taken (test sample) and introduced into a PFA (perfluoroalkoxy) tube for a HotBlock hot plate. 8 ml of 37% concentrated hydrochloric acid, 3 ml of 65% concentrated nitric acid and 0.5 ml of 40% hydrofluoric acid are then added. The tube is closed with a stopper and is heated at 130° C. for 2 h. After cooling, the contents are then transferred using ultrapure water into a 100 ml PTFE (polytetrafluoroethylene) volumetric flask already containing 2 g of boric acid (to neutralize the hydrofluoric acid). Ultrapure water is added up to the graduation mark. The solution obtained is diluted 100-fold, by taking 1 ml into a 100 ml PFTE flask already containing 8 ml of 37% concentrated hydrochloric acid, 3 ml of 65% concentrated nitric acid, 0.5 ml of 40% hydrofluoric acid and 2 g of boric acid. This diluted solution is then filtered on a 0.45 μm GHP syringe filter before being analysed by inductively coupled plasma atomic emission spectroscopy (ICP-AES). Prior to the analysis of the diluted solution, at least 5 standards are analysed by ICP-AES at zinc concentrations of 0, 0.5, 1, 2 and 5 mg/l. These standards were prepared in 100 ml volumetric flasks, by dilution of a commercial solution certified to a zinc concentration of 1 g/l.

These volumetric flasks already contain 8 ml of 37% concentrated hydrochloric acid, 3 ml of 65% concentrated nitric acid, 0.5 ml of 40% hydrofluoric acid and 2 g of boric acid. The standard solutions are analysed by ICP-AES at a wavelength of λZn=202.613 nm. For each standard concentration (c), the intensity of the zinc signal IZn is plotted on a graph IZn=f(c), which corresponds to the calibration curve (of type y=ax+b). The solution of the sample (diluted solution) of unknown concentration is then measured under the same conditions as the standards. The measured intensity is linked to the concentration by means of the previously obtained calibration curve. The concentration [c]ash in % by mass is thus obtained directly by the software, since the test sample and the volume have been recorded beforehand. The concentration of zinc in the pyrolysis black [c]black in % by mass is obtained by the following equation:

$${[ c ]}_{black} = {[ c ]}_{ash} * 100 * \% ash$$

The content of sulfur in the pyrolysis carbon blacks is determined using a LECO furnace. LECO sulfur analysers are designed to measure, in particular, the content of sulfur in organic and/or inorganic materials by combustion and nondispersive infrared detection. Before measuring the content of sulfur in the sample, the boats are cleaned and the furnace is calibrated. The boats for the LECO furnace are cleaned beforehand: this involves analysing the empty boat, under the same conditions as the samples. The calibration curve is prepared using a commercial standard called “BBOT” having a purity of greater than 99.99% and a guaranteed content of carbon (C), hydrogen (H), nitrogen (N), oxygen (O) and sulfur(S). This content is as follows: C %: 72.52; H %: 6.09; N %: 6.51; 0%: 7.43 and S %: 7.44. About exactly 10±3, 20±3 and 40±3 mg of BBOT are weighed into a boat. The standard/boat assembly is introduced into the combustion furnace, regulated at 1350° C. under pure oxygen. The combination of the temperature of the furnace and the analysis flow rate causes the combustion of the sample and the release of sulfur and/or carbon in the form of SO₂(g). After a time of 20 s, oxygen starts to flow through the lance in order to accelerate the combustion of materials that are difficult to burn. The sulfur and/or the carbon, in the form of SO₂(g), are entrained by a stream of oxygen through the infrared detection cells. The instrument software plots a curve linking the mass of standard introduced and the observed response (area) on the detector. A calibration curve is thus obtained. After having carefully cleaned the sampling equipment, about exactly 80+5 mg of pyrolysis carbon black are weighed out and introduced into a boat for the LECO furnace. The observed area of the SO₂ peak is linked to the concentration by means of the calibration curve. Using the mass of sample introduced into the boat, the instrument software then calculates the % by mass of sulfur in the sample.

Pyrolysis carbon blacks are sold, for example, by the company BlackBear under the reference BBCT30 or by the company Scandinavian Enviro Systems under the reference P550.

### Carbon Black

Suitable carbon blacks include all carbon blacks, particularly the blacks conventionally used in tyres or their treads, in particular industrial carbon blacks, more specifically “furnace” carbon blacks.

Among the carbon blacks having a CTAB specific surface area of greater than or equal to 90 m²/g, mention will more particularly be made of the reinforcing carbon blacks of the 100 and 200 series, such as for example the N115, N134 and N234 blacks (ASTM D-1765-2017 grades).

The carbon blacks may be used in the isolated state, as available commercially, or in any other form, for example as support for some of the rubber additives used. The carbon blacks might, for example, be already incorporated into the diene elastomer, especially isoprene elastomer, in the form of a masterbatch (see, for example, patent applications WO 97/36724-A2 and WO 99/16600-A1).

### Reinforcing Inorganic Filler

The term “reinforcing inorganic filler” should be understood here as meaning any inorganic or mineral filler, regardless of its colour and its origin (natural or synthetic), also known as “white” filler, “clear” filler or even “non-black” filler in contrast to carbon black, which is capable of reinforcing, by itself alone, without means other than an intermediate coupling agent, a rubber composition intended for the manufacture of tyres. In a known manner, certain reinforcing inorganic fillers can be characterized in particular by the presence of hydroxyl (—OH) groups at their surface.

Mineral fillers of the siliceous type, preferentially silica (SiO₂), or of the aluminous type, especially alumina (Al₂O₃), are suitable in particular as reinforcing inorganic fillers. The silica used may be any reinforcing silica known to those skilled in the art, in particular any precipitated or fumed silica having a BET specific surface area and also a CTAB specific surface area both of less than 450 m²/g, preferably in a range extending from 30 to 400 m²/g, in particular from 60 to 300 m²/g.

Use may be made of any type of precipitated silica, in particular highly dispersible precipitated silicas (HDS, for “highly dispersible silica”). These precipitated silicas, which may or may not be highly dispersible, are well known to a person skilled in the art. Mention may be made, for example, of the silicas described in patent applications WO 03/016215-A1 and WO 03/016387-A1. Among the commercial HDS silicas, use may notably be made of the Ultrasil® 5000GR and Ultrasil® 7000GR silicas from the company Evonik or the Zeosil® 1085GR, Zeosil® 1115 MP, Zeosil® 1165MP, Zeosil® Premium 200MP and Zeosil® HRS 1200 MP silicas from the company Solvay. Use may be made, as non-HDS silica, of the following commercial silicas: the Ultrasil® VN2GR and Ultrasil® VN3GR silicas from the company Evonik, the Zeosil® 175GR silica from the company Solvay or the Hi-Sil EZ120G(-D), Hi-Sil EZ160G(−D), Hi-Sil EZ200G(−D), Hi-Sil 243LD, Hi-Sil 210 and Hi-Sil HDP 320G silicas from the company PPG.

The BET specific surface area of the silica is determined in a known manner by gas adsorption using the Brunauer-Emmett-Teller method described in “The Journal of the American Chemical Society”, Vol. 60, page 309, February 1938, more specifically in accordance with the French standard NF ISO 9277 of December 1996 (multipoint (5 point) volumetric method—gas: nitrogen—degassing: 1 hour at 160° C.—relative pressure p/po range: 0.05 to 0.17). The CTAB specific surface area of the silica is determined in accordance with the French standard NF T 45-007 of November 1987 (method B).

Mention may also be made, as other examples of inorganic fillers capable of being used in the compositions, of mineral fillers of the aluminous type, in particular alumina (Al₂O₃), aluminium oxides, aluminium hydroxides, aluminosilicates, titanium oxides, silicon carbides or silicon nitrides, all of the reinforcing type as described, for example, in patent applications WO 99/28376-A2, WO 00/73372-A1, WO 02/053634-A1, WO2004/003067-A1, WO2004/056915-A2, U.S. Pat. No. 6,610,261-B1 and U.S. Pat. No. 6,747,087-B2. Mention may in particular be made of the aluminas Baikalox A125 or CR125 (Baikowski), APA-100RDX (Condea), Aluminoxid C (Evonik) or AKP-G015 (Sumitomo Chemicals). Although kaolin is mainly composed of aluminosilicates, it is well known to those skilled in the art that kaolin is not a reinforcing filler.

The physical state in which the reinforcing inorganic filler is provided is not important, whether this be in the form of a powder, of micropearls, of granules or else of beads or any other appropriate densified form. Of course, “reinforcing inorganic filler” is also understood also to mean mixtures of different reinforcing inorganic fillers, in particular of silicas as described above.

Those skilled in the art will understand that, as a replacement for the reinforcing inorganic filler described above, a reinforcing filler of another nature may be used, provided that this reinforcing filler of another nature is covered with an inorganic layer such as silica, or includes on its surface functional sites, notably hydroxyl sites, requiring the use of a coupling agent to establish the bond between this reinforcing filler and the diene elastomer. By way of example, mention may be made of carbon blacks partially or totally covered with silica, or carbon blacks modified with silica, such as, but not limited to, fillers of the Ecoblack® type of the CRX2000 series or of the CRX4000 series from the company Cabot Corporation.

Those skilled in the art will know how to adjust the total content of reinforcing filler according to the use concerned, in particular according to the type of tyres concerned, for example a tyre for a motorbike, for a passenger vehicle or for a utility vehicle, such as a van or heavy-duty vehicle.

In order to couple the reinforcing inorganic filler to the diene elastomer, use may be made, in a well-known manner, of an at least bifunctional coupling agent (or bonding agent) intended to provide a satisfactory connection, of chemical and/or physical nature, between the inorganic filler (surface of its particles) and the diene elastomer. Use is made in particular of organosilanes or polyorganosiloxanes which are at least bifunctional. The term “bifunctional” is understood to mean a compound having a first functional group capable of interacting with the inorganic filler and a second functional group capable of interacting with the diene elastomer. For example, such a bifunctional compound may comprise a first functional group comprising a silicon atom, said first functional group being capable of interacting with the hydroxyl groups of an inorganic filler, and a second functional group comprising a sulfur atom, said second functional group being capable of interacting with the diene elastomer.

Preferentially, the organosilanes are selected from the group consisting of organosilane polysulfides (symmetrical or asymmetrical), such as bis(3-triethoxysilylpropyl) tetrasulfide, TESPT for short, sold under the name Si69 by the company Evonik, or bis(triethoxysilylpropyl) disulfide, TESPD for short, sold under the name Si75 by the company Evonik, polyorganosiloxanes, mercaptosilanes, blocked mercaptosilanes, such as S-(3-(triethoxysilyl) propyl) octanethioate, sold by the company Momentive under the name NXT Silane.

More preferentially, the organosilane is an organosilane polysulfide.

Those skilled in the art can find examples of coupling agents in the following documents: WO 02/083782, WO 02/30939, WO 02/31041, WO 2007/061550, WO 2006/125532, WO 2006/125533, WO 2006/125534, U.S. Pat. No. 6,849,754, WO 99/09036, WO 2006/023815, WO 2007/098080, WO 2010/072685 and WO 2008/055986.

The content of coupling agent preferentially represents from 0.5% to 15% by weight relative to the amount of reinforcing inorganic filler, preferably from 4% to 12%, more preferably from 6% to 10%, by weight relative to the amount of reinforcing inorganic filler.

Typically, the content of coupling agent is less than 20 phr, preferentially within a range extending from 6 to 17 phr, preferably from 8 to 15 phr. This content can easily be adjusted by those skilled in the art according to the content of inorganic filler used in the composition.

The composition may also comprise, in addition to the coupling agents, coupling activators, agents for covering the inorganic fillers or more generally processing aids capable, in a known manner, by virtue of an improvement in the dispersion of the filler in the rubber matrix and of a lowering in the viscosity of the compositions, of improving their ease of processing in the raw state, these processing aids being, for example, hydrolysable silanes such as alkylalkoxysilanes (in particular alkyltriethoxysilanes), polyols, polyethers (for example polyethylene glycols), primary, secondary or tertiary amines (for example trialkanolamines), hydroxylated or hydrolysable POSs, for example α,ω-dihydroxypolyorganosiloxanes (in particular α,ω-dihydroxypolydimethylsiloxanes), or fatty acids, for instance stearic acid.

### Crosslinking System

The composition of use in the context of the invention comprises a crosslinking system. The crosslinking system may be any type of system known to those skilled in the art in the field of rubber compositions for tyres. It may in particular be based on sulfur and/or on peroxide and/or on bismaleimides.

Preferentially, the crosslinking system is based on sulfur; it is then referred to as a vulcanization system. The sulfur can be contributed in any form, in particular in the form of molecular sulfur or of a sulfur-donating agent. At least one vulcanization accelerator is also preferentially present, and, optionally, also preferentially, use may be made of various known vulcanization activators, such as zinc oxide, stearic acid or an equivalent compound, such as stearic acid salts, and salts of transition metals, guanidine derivatives (in particular diphenylguanidine), or also known vulcanization retarders. Sulfur is used in a preferential content of between 0.5 and 10 phr, in particular between 1 and 5 phr. The vulcanization accelerator is used in a preferential content of between 0.5 and 10 phr, more preferentially between 0.5 and 5.0 phr.

Use may be made, as accelerator, of any compound capable of acting as accelerator of the vulcanization of diene elastomers in the presence of sulfur, in particular accelerators of the thiazole type, and also derivatives thereof, or accelerators of sulfenamide, thiuram, dithiocarbamate, dithiophosphate, thiourea and xanthate types. Mention may in particular be made, as examples of such accelerators, of the following compounds: 2-mercaptobenzothiazyl disulfide (abbreviated to MBTS), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), tetrabenzylthiuram disulfide (TBZTD), zinc dibenzyldithiocarbamate (ZBEC) and the mixtures of these compounds.

### Usual Additives and Processing Aids

The composition of use in the context of the invention may also comprise all or some of the usual additives and processing aids which are known to those skilled in the art and are customarily used in rubber compositions for tyres, in particular in compositions intended for the manufacture of tyre outer sidewalls, for instance plasticizers (such as plasticizing oils and/or plasticizing resins having or not having a tackifying nature), non-reinforcing fillers, pigments, protective agents such as anti-ozone waxes, chemical anti-ozonants, antioxidants, anti-fatigue agents, reinforcing resins (as described, for example, in application WO 02/10269).

In certain embodiments, the composition of use in the context of the present invention comprises a plasticizer. The content of plasticizer is then greater than 0 and less than or equal to 10 phr, for example from 1 to 5 phr.

The plasticizer is preferably selected from hydrocarbon resins, plasticizing oils and mixtures thereof.

Plasticizing oils selected from the group consisting of naphthenic oils (of high or low viscosity, in particular hydrogenated or non-hydrogenated), paraffinic oils, MES (Medium Extracted Solvate) oils, TDAE (Treated Distillate Aromatic Extract) oils, RAE (Residual Aromatic Extract) oils, TRAE (Treated Residual Aromatic Extract) oils, SRAE (Safety Residual Aromatic Extract) oils, mineral oils, vegetable oils, ether plasticizers, ester plasticizers, phosphate plasticizers, sulfonate plasticizers, and mixtures of these compounds, are particularly suitable.

Hydrocarbon resins, also known as hydrocarbon plasticizing resins, are polymers that are well known to those skilled in the art, essentially based on carbon and hydrogen but which may include other types of atoms, for example oxygen, and can be used in particular as plasticizers or tackifiers in polymeric matrices. They are by nature at least partially miscible (i.e. compatible) at the contents used with the polymer compositions for which they are intended, so as to act as true diluents. They have been described, for example, in the book entitled “Hydrocarbon Resins” by R. Mildenberg, M. Zander and G. Collin (New York, VCH, 1997, ISBN 3-527-28617-9), Chapter 5 of which is devoted to their applications, particularly in the tyre rubber engineering field (5.5. “Rubber Tires and Mechanical Goods”). In a known manner, these hydrocarbon resins can also be described as thermoplastic resins in the sense that they soften when heated and can thus be moulded.

The softening point of hydrocarbon resins is measured according to the standard ISO 4625 (“ring and ball” method). The Tg is measured according to the standard ASTM D3418 (1999). The macrostructure (Mw, Mn and PDI) of the hydrocarbon resin is determined by size exclusion chromatography (SEC); solvent tetrahydrofuran; temperature 35° C.; concentration 1 g/l; flow rate 1 ml/min; solution filtered through a filter with a porosity of 0.45 μm before injection; Moore calibration with polystyrene standards; set of 3 Waters columns in series (Styragel HR4E, HR1 and HR0.5); detection by differential refractometer (Waters 2410) and its associated operating software (Waters Empower).

The hydrocarbon resins may be aliphatic, aromatic or of the aliphatic/aromatic type, i.e. based on aliphatic and/or aromatic monomers. They may be natural or synthetic and may or may not be petroleum-based (if such is the case, they are also known as petroleum resins).

Examples of aromatic monomers that are suitable include styrene, α-methylstyrene, indene, ortho-, meta-, para-methylstyrene, vinyltoluene, para-tert-butylstyrene, methoxystyrenes, chlorostyrenes, vinylmesitylene, divinylbenzene, vinylnaphthalene and any vinylaromatic monomer derived from a C9 cut (or more generally from a C8 to C10 cut). Preferably, the vinylaromatic monomer is styrene or a vinylaromatic monomer derived from a C9 cut (or more generally from a C8 to C10 cut). Preferably, the vinylaromatic monomer is the minor monomer, expressed as a mole fraction, in the copolymer under consideration.

According to a particularly preferential embodiment, the hydrocarbon plasticizing resin is selected from the group consisting of cyclopentadiene (abbreviated to CPD) or dicyclopentadiene (abbreviated to DCPD) homopolymer or copolymer resins, terpene homopolymer or copolymer resins, terpene phenol homopolymer or copolymer resins, C5 cut homopolymer or copolymer resins, C9 cut homopolymer or copolymer resins, α-methylstyrene homopolymer and copolymer resins and mixtures of these resins.

The term “terpene” groups together here, in a known way, α-pinene, β-pinene and limonene monomers, the limonene monomer existing, in a known way, in the form of three possible isomers: L-limonene (laevorotatory enantiomer), D-limonene (dextrorotatory enantiomer) or else dipentene, a racemate of the dextrorotatory and laevorotatory enantiomers. Mention will in particular be made, among the above hydrocarbon plasticizing resins, of α-pinene, β-pinene, dipentene or polylimonene homopolymer or copolymer resins.

High-Tg hydrocarbon resins are known to be thermoplastic hydrocarbon resins with a Tg of greater than 20° C.

Preferably, the plasticizing resin is a high-Tg hydrocarbon plasticizing resin having at least any one of the following features:
a Tg of greater than 30° C.;
a number-average molecular mass (Mn) of between 300 and 2000 g/mol, more preferentially between 400 and 1500 g/mol;
a polydispersity index (PDI) of less than 3, more preferentially of less than 2 (as a reminder: PDI=Mw/Mn with Mw being the weight-average molecular mass).

More preferentially, this high-Tg hydrocarbon plasticizing resin has all of the above preferential features.

The above preferential high-Tg hydrocarbon resins are well known to those skilled in the art and are commercially available, for example sold, as regards:
polylimonene resins: by the company DRT under the name Dercolyte L120 (Mn=625 g/mol; Mw=1010 g/mol; PDI=1.6; Tg=72° C.) or by the company Arizona under the name Sylvagum TR7125C (Mn=630 g/mol; Mw=950 g/mol; PDI=1.5; Tg=70° C.);
C5 cut/vinylaromatic copolymer resins, in particular C5 cut/styrene or C5 cut/C9 cut copolymer resins: by Neville Chemical Company under the names Super Nevtac 78, Super Nevtac 85 or Super Nevtac 99, by Goodyear Chemicals under the name Wingtack Extra, by Kolon under the names Hikorez T1095 and Hikorez T1100, by Exxon under the names Escorez 2101 and Escorez 1273;
limonene/styrene copolymer resins: by DRT under the name Dercolyte TS 105, by the company DRT, by Arizona Chemical Company under the names ZT115LT and ZT5100.

Mention may also be made, as examples of other preferential resins, of phenol-modified α-methylstyrene resins. In order to characterize these phenol-modified resins, it should be remembered that a number referred to as “hydroxyl number” (measured according to the standard ISO 4326 and expressed in mg KOH/g) is used in a known way. α-Methylstyrene resins, in particular phenol-modified ones, are well known to those skilled in the art and are commercially available, for example sold by the company Arizona Chemical under the names Sylvares SA 100 (Mn=660 g/mol; PDI=1.5; Tg=53° C.); Sylvares SA 120 (Mn=1030 g/mol; PDI=1.9; Tg=64° C.); Sylvares 540 (Mn=620 g/mol; PDI=1.3; Tg=36° C.; hydroxyl number=56 mg KOH/g); and Sylvares 600 (Mn=850 g/mol; PDI=1.4; Tg=50° C.; hydroxyl number=31 mg KOH/g).

Mention may also be made of the resins of the alkylphenol family, such as octylphenyl formaldehyde (OPF), which are available for example under the name SP 1068 from the company SI Group, and also gum rosin, such as those provided by the company Costa Irmaos.

### Manufacture of the Compositions

The rubber composition of use in the context of the invention is manufactured in appropriate mixers using two successive preparation phases that are well known to those skilled in the art:
a first phase of thermomechanical working or kneading (“non-productive” phase), which can be performed in a single thermomechanical step during which all the necessary constituents, in particular the elastomeric matrix, the fillers and the various other optional additives, with the exception of the crosslinking system, are introduced into an appropriate mixer, such as a standard internal mixer (for example of Banbury type). The incorporation of the filler into the elastomer may be carried out in one or more portions while thermomechanically kneading. If the filler is already incorporated, totally or partially, in the elastomer in the form of a masterbatch, as is described, for example, in patent applications WO 97/36724 or WO 99/16600, it is the masterbatch which is directly kneaded and, where appropriate, the other elastomers or fillers present in the composition which are not in masterbatch form, and also the various other optional additives, with the exception of the crosslinking system, are incorporated.

The non-productive phase is carried out at high temperature, up to a maximum temperature of between 130° C. and 170° C., for a period of time generally of between 2 and 10 minutes.
a second phase of mechanical working (“productive” phase), which is carried out in an external mixer, such as an open mill, after cooling the mixture obtained during the first non-productive phase down to a lower temperature, typically of less than 110° C., for example between 40° C. and 100° C. The crosslinking system is then incorporated and the combined mixture is then mixed for a few minutes, for example between 1 and 30 min.

The final composition thus obtained is subsequently calendered, for example in the form of a sheet or of a slab, in particular for a laboratory characterization, or is extruded in the form of a rubber semi-finished (or profiled) element which can be used, for example, as an internal layer in a tyre.

The composition may be either in the raw state (before crosslinking or vulcanization) or in the cured state (after crosslinking or vulcanization), or may be a semi-finished product which can be used in a tyre.

The crosslinking of the composition may be performed in a manner known to those skilled in the art, for example at a temperature of between 130° C. and 200° C., preferably under pressure, for a sufficient time which can vary, for example, between 5 and 90 min. The examples that follow are given by way of illustration but should in no case be considered to limit the present invention.

### Tyres

The tyre according to the invention is intended to equip motor vehicles of passenger vehicle type, SUVs (“Sport Utility Vehicles”), or two-wheel vehicles (especially motorcycles), or aircraft, or also industrial vehicles selected from vans, heavy-duty vehicles-that is to say, underground trains, buses, heavy road transport vehicles (lorries, tractors, trailers) or off-road vehicles, such as heavy agricultural vehicles or civil engineering vehicles—, and others. Preferably, the tyre according to the invention is particularly suitable for equipping vehicles of passenger vehicle, van and SUV type.

The examples that follow are given by way of illustration. They should in no case be considered to limit the present invention.

### EXAMPLES

### Dynamic Properties:

The dynamic properties, in particular G*10% return at 60° C. and G″10% return at 60° C., representative of the stiffness and the hysteresis, respectively, are measured on a viscosity analyser (Metravib VA4000), in accordance with the standard ASTM D 5992-96. The response of a sample of the vulcanized composition (cylindrical test specimens with a thickness of 4 mm and with a cross section of 400 mm²), subjected to a simple alternating sinusoidal shear stress, at a frequency of 10 Hz, at a temperature of 60° C., is recorded.

For the measurements of complex dynamic shear modulus (G*) and the loss factor (G″), a strain amplitude sweep is carried out from 0.1% to 100% peak-to-peak (outward cycle), and then from 100% to 0.1% peak-to-peak (return cycle). For the return cycle, the observed value of G″10% and also the G* modulus at 10% strain, denoted G*10%, are indicated.

The results are expressed in base 100 relative to the control (the value of 100 is given to the control).

### Tensile Tests:

These tensile tests make it possible to determine the elasticity stresses and the properties at break. Unless otherwise indicated, they are carried out in accordance with the French standard NF T 46-002.

Processing the tensile recordings makes it possible in particular to plot the curve of modulus as a function of elongation. The modulus used here is the nominal (or apparent) secant modulus measured in first elongation, calculated by normalizing to the initial cross section of the test specimen. The nominal secant modulus (or apparent stress, in MPa) is measured in first elongation at 10% and 300% elongation, respectively denoted MSA10 and MSA300.

Also measured are the strains at break and the tearability energy at break at 23° C. at 100° C.+/−2° C., in accordance with the standard NFT 46-002, on samples cured at 140° C. for 50 min.

The results are expressed in base 100 relative to the control (the value of 100 is given to the control).

### Tearability

The tensile tests make it possible to determine the moduli of elasticity and the properties at break and are based on the standard NF ISO 37 of December 2005.

The tearability indices are measured at 23° C. The force to be exerted in order to obtain breaking (in N/mm) is determined in particular, and the strain at break (in %) is measured on a test specimen with dimensions of 10×85×2.5 mm notched at the centre of its length with 3 notches over a depth of 5 mm, in order to cause the test specimen to break. Thus, the energy to cause the test specimen to break, which is the product of the breaking force and the breaking strain, can be determined. The results are given in base 100, i.e. the values are expressed relative to a control, the measured value of which is considered as the reference at 100.

Thus, a lower value of the energy at break represents a decrease in tear strength performance (that is to say a decrease in the energy at break), whereas a higher value represents a better performance.

### Swelling Index

The swelling index is determined by means of a Rheograph 75 rheometer equipped with a camera system (i2S, reference 21400328).

The rheometer consists of 2 identical and parallel tanks (20 mm diameter). The tanks are heated to the test temperature. A single tank is used for the measurement of swelling (barrel number 1).

The mixture to be tested is placed in the tank; it is then compressed by a piston which forces this mixture to be discharged through the die (extrusion of the mixture) located at the bottom of the tank. The length, the diameter and the surface condition of the two dies are known. The piston moves at various speed levels predefined by the user. The pressure is measured throughout the acquisition in order to be able to calculate the rheological characteristics of the material.

The measurement result is the result of a single measurement. The result obtained is a swelling index (unitless number) for each speed level.

$$Swelling Index = \frac{Extrudate diameter}{Die diameter}$$

The results are expressed in base 100 relative to the control (the value of 100 is given to the control).

### Preparation of the Rubber Compositions:

The compositions are manufactured in appropriate mixers, using two successive phases of preparation which are well known to those skilled in the art: a first phase of thermomechanical working or kneading (sometimes referred to as “non-productive” phase) at high temperature, up to a maximum temperature of between 110° C. and 200° C., preferably between 130° C. and 180° C., followed by a second phase of mechanical working (sometimes referred to as “productive” phase) at lower temperature, typically below 110° C., for example between 60° C. and 100° C., during which finishing phase the crosslinking or vulcanization system is conventionally incorporated; such phases have been described, for example, in applications EP-A-0501227, EP-A-0735088, EP-A-0810258, WO 00/05300 or WO 00/05301.

The compositions are cured at 140° C. for 50 min.

### Tests

Tests were carried out with various rubber compositions presented in Table 1.

The formulations of the compositions prepared are described in Table 1 (components and content—unless otherwise indicated, the contents are expressed in phr).

TABLE 1
formulations of the compositions

| | T | C1 | C2 | INV |
|---|---|---|---|---|
| Natural rubber | 50.00 | 50.00 | 50.00 | 50.00 |
| Polybutadiene | 50.00 | 50.00 | 50.00 | 50.00 |
| Carbon black, ASTM N234 | 33.50 | 3.00 | 3.00 | 3.00 |
| grade | | | | |
| Pyrolysis carbon black (2) | | | | 16.25 |
| Silica (3) | 10.00 | 33.00 | 51.50 | 33.00 |
| Antioxidant (4) | 8.90 | 8.90 | 8.90 | 8.90 |
| Anti-ozone wax | 1.34 | 1.34 | 1.34 | 1.34 |
| Sunflower oil | 11.50 | 11.50 | 11.50 | 11.50 |
| Zinc oxide (5) | 2.50 | 2.50 | 2.50 | 2.50 |
| Stearic acid (6) | 1.00 | 1.00 | 1.00 | 1.00 |
| Liquid silane Si69 | 0.50 | 3.30 | 3.30 | 3.30 |
| Accelerator (7) | 0.90 | 0.90 | 0.90 | 0.90 |
| Sulfur | 1.80 | 1.80 | 1.80 | 1.80 |
| Activator (8) | — | 0.33 | 0.33 | 0.33 |

(1) WTR80-0 sold by the company Lehigh Technologies
(2) P550 sold by the company Scandinavian Enviro Systems ((%) ash: 18.5; (%) sulfur: 3; (%) zinc: 4.5; STSA specific surface area: 56 m²/g (ASTM D6556-2021); void volume at 50 MPa: 44 ml/100 g (ASTM D7854-21))
(3) Ultrasil ® 7000GR sold by the company Evonik
(4) Combination of two antioxidants TMQ ((N-(1,3-dimethylbutyl)-N-phenyl-para-phenylenediamine (Santoflex 6-PPD from Flexsys) and 2,2,4-trimethyl-1,2-dihydroquinilone (TMQ from Lanxess)
(5) Zinc oxide (industrial grade), sold by the company Umicore
(6) Stearin sold by the company Uniqema under the name Pristerene 4931
(7) N-Cyclohexyl-2-benzothiazolesulfenamide sold by the company Flexsys under the name Santocure CBS
(8) Diphenylguanidine, Perkacit DPG from the company Flexsys

Table 1: formulations of the compositions
(1) WTR80-0 sold by the company Lehigh Technologies
(2) P550 sold by the company Scandinavian Enviro Systems ((%) ash: 18.5; (%) sulfur: 3; (%) zinc: 4.5; STSA specific surface area: 56 m²/g (ASTM D6556-2021); void volume at 50 MPa: 44 ml/100 g (ASTM D7854-21))
(3) Ultrasil® 7000GR sold by the company Evonik
(4) Combination of two antioxidants TMQ ((N-(1,3-dimethylbutyl)-N-phenyl-para-phenylenediamine (Santoflex 6-PPD from Flexsys) and 2,2,4-trimethyl-1,2-dihydroquinolone (TMQ from Lanxess)
(5) Zinc oxide (industrial grade), sold by the company Umicore
(6) Stearin sold by the company Uniqema under the name Pristerene 4931 (7)N-Cyclohexyl-2-benzothiazolesulfenamide sold by the company Flexsys under the name Santocure CBS
(8) Diphenylguanidine, Perkacit DPG from the company Flexsys

The properties of the compositions measured in the cured state are presented in Table 2.

TABLE 2
properties of the compositions

| | | | |
|---|---|---|---|
| T | C1 | C2 | INV |

% by volume expressed relative to the
total volume of the composition

| | | | | |
|---|---|---|---|---|
| Silica | 3 | 10 | 15 | 10 |
| N234 | 12 | 1 | 1 | 1 |
| Other fillers | — | — | — | 5 |
| TOTAL | 15 | 11 | 16 | 16 |
| Strain at break | 100 | 91 | 102 | 100 |
| base 100 | | | | |
| Tearability breaking | 100 | 43 | 188 | 151 |
| energy at 23° C. | | | | |
| base 100 | | | | |
| G″10% return | 100 | 56 | 163 | 105 |
| base 100 | | | | |
| SI 80 s−1 | 100 | 136 | 129 | 121 |
| base 100 | | | | |

### Table 2: Properties of the Compositions

The tests carried out show that a decrease in the content of reinforcing fillers in a rubber composition leads to compositions exhibiting gains in hysteresis (compositions T and C1). However, this gain in hysteresis is accompanied by a decrease in the tearability breaking energy and a deterioration in the processability of the compositions (SI 80 s-1). Specifically, the swelling of the compositions reaches levels that degrade the performance of the compositions with respect to use in the industrial equipment commonly employed.

By comparing compositions C1 and C2, it can be observed that an increase in the total volume of filler makes it possible to reduce the swelling. However, this effect is accompanied by a deterioration in the rolling resistance performance qualities (increase in the G″10% return).

Surprisingly, it has been observed that, with an identical total volume of filler (comparison of the compositions C2 and INV), the partial substitution of the silica with pyrolysis carbon black makes it possible to achieve a good performance qualities/processability compromise.

1.-12. (canceled)

13. A tire provided with an outer sidewall, the outer sidewall comprising at least one rubber composition based on:
at least one elastomer;
16% to 20% by volume, relative to a total volume of the rubber composition, of reinforcing fillers; and
a crosslinking system,
wherein the reinforcing fillers comprise:
from 6% to 16% by volume, relative to the total volume of the rubber composition, of reinforcing fillers selected from the group consisting of reinforcing inorganic fillers, carbon blacks having a CTAB specific surface area of greater than or equal to 90 m²/g and mixtures of reinforcing inorganic fillers and of carbon blacks having a CTAB specific surface area of greater than or equal to 90 m²/g in which the reinforcing inorganic filler is predominant by mass; and
pyrolysis carbon blacks in an amount sufficient to achieve a volume of reinforcing fillers in the composition ranging from 16% to 20% relative to a total volume of the rubber composition.

14. The tire according to claim 13, wherein the or each elastomer is a diene elastomer selected from the group consisting of polybutadienes (BR), natural rubber (NR), synthetic polyisoprenes (IR), butadiene copolymers, isoprene copolymers, and the mixtures of these elastomers.

15. The tire according to claim 13, wherein the rubber composition comprises from 25 to 100 phr of natural rubber and from 0 to 75 phr of at least one polybutadiene.

16. The tire according to claim 15, wherein the rubber composition comprises 50 phr of natural rubber and 50 phr of polybutadiene.

17. The tire according to claim 13, wherein the carbon blacks having a CTAB specific surface area of greater than or equal to 90 m²/g are selected from the reinforcing carbon blacks of the 100 and 200 series.

18. The tire according to claim 13, wherein the reinforcing inorganic fillers are silica.

19. The tire according to claim 13, wherein the crosslinking system is a vulcanization system based on molecular sulfur and/or on a sulfur-donating agent.

20. The tire according to claim 19, wherein the vulcanization system comprises between 0.5 and 10 phr of sulfur.

21. The tire according to claim 13, wherein the pyrolysis carbon black has an ash content ranging from 5% to 30% by weight, relative to a total weight of the pyrolysis carbon black.

22. The tire according to claim 13, wherein the pyrolysis carbon black has a sulfur content of greater than 2% by weight, relative to a total weight of the pyrolysis carbon black.

23. The tire according to claim 13, wherein the rubber composition further comprises one or more agents selected from the group consisting of plasticizers, non-reinforcing fillers, pigments, protective agents, chemical anti-ozonants, antioxidants, anti-fatigue agents and reinforcing resins.

24. The tire according to claim 13, wherein the reinforcing fillers are reinforcing inorganic fillers or mixtures of reinforcing inorganic fillers and of carbon blacks having a CTAB specific surface area of greater than or equal to 90 m²/g in which the reinforcing inorganic filler is predominant by mass.

25. The tire according to claim 13, wherein the reinforcing fillers comprise from 6% to 11%, by volume, relative to a total volume of the rubber composition, of reinforcing fillers.

26. The tire according to claim 20, wherein the vulcanization system comprises between 1 and 5 phr of sulfur.

27. The tire according to claim 21, wherein the pyrolysis carbon black has an ash content ranging from 8% to 25% by weight, relative to the total weight of the pyrolysis carbon black

28. The tire according to claim 22, wherein the pyrolysis carbon black has a sulfur content ranging from 2.5% to 5% by weight, relative to the total weight of the pyrolysis carbon black.
